(19) United States
(12) Patent Application Publication
(10) Pub. No.: US 2007/0055620 A1
(43) Pub. Date: Mar. 8, 2007

(54) Method and Apparatus for Creating a Benefit Plan

(76) Inventors: Frederick Garcia, Huntington Beach, CA (US); Brenda Garcia, Huntington Beach, CA (US); Rico Garcia, Huntington Beach, CA (US); Ronald Truss, Highland, CA (US); Lester J. Marston, Willits, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/420,210

(22) Filed: May 24, 2006

Related U.S. Application Data
(63) Continuation-in-part of application No. 11/218,752, filed on Sep. 2, 2005.

(51) Int. Cl. G06Q 40/00

(52) U.S. Cl. 705/38

(57) ABSTRACT

A benefit plan for a member of a Native American Indian tribe comprises providing a life insurance policy having a policy benefit to the member. A premium payment for the policy is received, wherein at least a portion of the premium payment is obtained from loan proceeds generated by a loan from the tribe to the member. At least a portion of the loan proceeds is money that otherwise would be paid to the member as unearned income. At least a portion of the policy benefit is to be placed into a fund established pursuant to tribal law. A sum of money corresponding to the policy benefit is to be paid from the fund to the member upon the fulfillment by the member of a plurality of conditions.

### CROSS REFERENCE TO RELATED APPLICATIONS

This is a continuation-in-part application which claims priority from U.S. patent application Ser. No. 11/218,752, filed Sep. 2, 2005.

1. Field of Invention

This relates in general to a method and apparatus for creating a benefit plan. More particularly, this relates to a method and apparatus for creating a plan for a Native American Indian tribal member that is funded by money paid by the tribe.

2. Background

Native American Indian tribes are treated differently from non-governmental entities. That treatment stems from the unique legal status of Indian tribes and the federal government's stated policy of respecting tribal self-determination, territorial integrity, and economic development. (See, e.g., Indian Reorganization Act, 25 U.S.C. §461 et seq., the Indian Gaming Regulatory Act, 25 U.S.C. §2701 et seq.) Included in this unique status is the authorization for some tribes to conduct gaming operations. For some tribes, these gaming operations result in profits that are distributed to the tribal members as “per capita” payments.

The nature of the relationship between a tribe and its members is unusual. The tribal member's income from per capita payments is considered to be “unearned” as that term is used within the meaning of the federal tax code. That is, a per capita payment is not the result of any job, wage or similar compensation arrangement, but rather, is a payment issued by a tribal government to an individual member as part of a government program.

For some tribes, the per capita distributions from gaming are high at this point in time. However, these high levels of distributions are not guaranteed to last. Thus it would be desirable to have a savings mechanism whereby a portion of these distributions can be saved and invested on a tax-deferred basis, so that if the current per capita distributions decrease, tribal members will still have financial resources. Commonly-known, tax-deferred retirement plans include 401 (k) and IRA plans. However, tribal members are not able to use these plans for per capita distributions since these plans are employer-sponsored or earned-income (e.g. salary) based.

What is needed therefore is an improved, long-term financial security mechanism for per capita income that grows in value on a tax-deferred basis.

### SUMMARY OF THE ILLUSTRATED EMBODIMENTS

Methods and apparatuses for creating a benefit plan for a member of a Native American Indian tribe are provided.

In one aspect, a method comprises providing a life insurance policy to be owned by the member and having a policy benefit comprising a death benefit and a cash surrender value. A premium payment for the life insurance policy is received, wherein at least a portion of the premium payment is obtained from loan proceeds generated by a first loan from the Native American Indian tribe to the member. At least a portion of the loan proceeds is money that otherwise would be paid by the Native American Indian tribe to the member as unearned income.

At least a portion of the policy benefit is to be paid to the Native American Indian tribe for placement into a fund established pursuant to tribal law. A first sum of money corresponding to the policy benefit is to be paid from the fund to the member upon the fulfillment by the member of a plurality of conditions. The use of the fund is limited to handling money corresponding to the policy benefit and the first sum of money.

In another aspect, the portion of the policy benefit is a second sum of money, wherein the first sum of money is approximately equal to the second sum of money plus gains associated with investment of the second sum of money, minus losses associated with the investment of the second sum of money, minus at least a portion of administration costs relating to administration of the fund.

In another aspect, one of the plurality of conditions includes one of the following: the attainment by the member of a predetermined age, the providing by the member of an election relating to an age of the member for commencement of receiving at least a portion of the first sum of money, the providing by the member of an election relating to a rate of payment by the Native American Indian tribe of the first sum of money to the member, or the repayment by the member of the first loan.

In yet another aspect, if the member dies prior to a predetermined age, a predetermined sum of money is to be paid by the Native American Indian tribe to either the estate or the beneficiary of the member, but the first sum of money is not to be paid to the estate or beneficiary of the member. The amount of the predetermined sum of money is established by the North American Indian tribe prior to the death of the member.

There are additional aspects to the present inventions. It should therefore be understood that the preceding is merely a brief summary of some embodiments and aspects of the present inventions. Additional embodiments and aspects of the present inventions are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of the preferred embodiments, taken in conjunction with the accompanying drawings of which:

FIG. 1 is a simplified hardware system diagram showing a computer environment in accordance with an embodiment of the present invention;

FIG. 2 is a simplified illustration of a per capita payment and related tax effects;

FIG. 3 is a simplified illustration of contractual arrangements between a tribe, a tribal member and an insurance provider in accordance with an embodiment of the invention;

FIG. 4 is a simplified illustration showing the flow of funds between various entities at the beginning and end of a time period in accordance with an embodiment of the invention;

FIG. 5 is an illustration chart of an exemplary build-up of a death benefit and cash surrender value in a life insurance policy over time in accordance with an embodiment of the invention;

FIG. 6 is a flow chart diagram of a benefit plan in accordance with an embodiment of the invention; and

FIG. 7 is a simplified illustration showing the flow of funds between various entities at the beginning and end of a time period in accordance with another embodiment of the invention.

### DETAILED DESCRIPTION

Reference will now be made in detail to embodiments of the present invention, examples of which are illustrated in the accompanying drawings, wherein like reference numerals refer to like elements throughout. It is understood that other embodiments may be utilized and structural and operational changes may be made without departing from the scope of the present invention.

Disclosed is a tax-deferred benefit plan involving the use of a split-dollar life insurance and loan arrangement. According to one embodiment of the invention, the arrangement is created between a Native American Indian tribe and an individual tribal member, utilizing a loan agreement, promissory notes, a collateral assignment agreement, and an insurance policy. The arrangement is between the tribe, a quasi-sovereign governmental entity, and one of the tribe's members.

In general, a split-dollar life insurance arrangement is an arrangement between two or more parties to allocate the policy benefits and, in some cases, the costs of a life insurance contract. Internal Revenue Service (“IRS”) regulations generally define a split-dollar life insurance arrangement more narrowly to be any arrangement between an owner of a life insurance contract and a non-owner of the contract under which either party to the arrangement pays all or part of the premiums, and one of the parties paying the premiums is entitled to recover (either conditionally or unconditionally) all or any portion of those premiums and such recovery is to be made from, or is secured by, the proceeds of the contract. The IRS definition does not cover the purchase of an insurance contract in which the only parties to the arrangement are the policy owner and the life insurance company acting only in its capacity as issuer of the contract.

According to one embodiment of the invention, a split-dollar life insurance arrangement is employed whereby the tribe uses a portion of what otherwise would be the member's unearned income payable by the tribe as an interest-free loan extended to the member in order to pay the premiums on a life insurance policy. The revenue for the unearned income is generated from business operations of the tribe, such as gaming, lumber, oil, mining, tourism, etc. The policy provides the tribal member's beneficiaries or estate with substantial death benefits. A portion of the premium payment is placed in an investment portfolio within the life insurance plan whereby the portfolio is chosen by the tribal member. As the portfolio value grows, the policy benefit comprising the cash surrender value and the death benefit of the life insurance policy will grow. The life insurance policy is a variable universal life policy, although in other embodiments other policies, such as universal life policies or whole life policies could be used as well.

The reduction in the tribal member's unearned income payment (such as for example, a per capita payment), meanwhile, will reduce the member's taxable income and, therefore, reduce his/her current-year tax liability. At the end of the loan period, the tribal member will repay the loan via insurance policy proceeds.

The benefits of the split-dollar life insurance arrangement to the tribal member may include: financial security for the beneficiaries of the life insurance policy, long term investment growth on pre-tax money, and reduced tax liability during the period of the loan.

The benefits of this method are also significant from the point of view of the tribe since it has a continuing concern about the long-term welfare of the members of the tribe. The split-dollar life insurance method described here may help to ensure that, years from now, tribal members and their families will have a dependable source of income other than tribal unearned income (e.g., per capita) payments. This requires relatively few demands on tribal government personnel and resources. The tribe is responsible for accounting for the loans, the reporting to the IRS of the income from the transaction (e.g., the imputed interest on the loan), withholding taxes, etc. The tribe incurs no significant or large new costs, because the money to be used for the method is from funds that would otherwise be distributed to members as unearned income payments from funds that are generated by the business operations of the tribe.

A component of this arrangement is that it meet the requirements of Section 7872 of the Internal Revenue Code (26 U.S.C. §7872) and the regulations that have been enacted to implement that section (26 CFR § 1.6, 26 CFR § 1.7872-15). It is in this respect that certain embodiments of the invention are unique, since to the inventors' knowledge, no other similar arrangement for an Indian tribe and their members is known to meet the requirements of the federal regulations relating to split-dollar life insurance arrangements.

According to one embodiment of the invention, a tribal member enters into a split-dollar loan agreement with a tribe. The loan agreement requires the tribe to provide the member with annual, no-interest, loans to be used exclusively for the payment of annual premiums on a life insurance policy for the member, as the owner of the policy. Along with the loan agreement, the member and the tribe enter into two related agreements: a promissory note and a collateral assignment agreement.

The agreements prohibit the member from using any money loaned to him or her under the agreements for any purpose other than the funding of the life insurance policy. To ensure that the loans are used exclusively for the payment of the insurance premiums, the loans are issued in the form of premium payments made directly from the tribe to the insurance provider. The agreements require the repayment of the loan/premium payments by the member, and the repayment of the loan is fully recourse to the member. The repayment is effected by the insurance policy which provides for payment of at least a portion of the cash surrender value and death benefit directly from the insurance company to the tribe.

At the outset, the tribe issues an authorization pursuant to tribal law, such as for example a resolution, stating that the tribe wishes to carry out the transaction, including a waiver of the tribe's sovereign immunity for the purposes of enforcement of the provisions of the agreement. The tribe acts as the initiating party and therefore is responsible for all tax withholding, reporting, and record keeping of any monies loaned to the member, including the identification and accounting of each premium as a separate loan, the reporting of imputed interest, and the creation and delivery of IRS Forms 1099 to the member.

A percentage of what otherwise would be the member's present per capita (or other unearned income) payment is used to fund the payment of the premiums on a life insurance policy through loans to the member. It is believed that this arrangement qualifies as a split-dollar life insurance arrangement as defined in 26 CFR §1.61. Under this arrangement the tribe makes the loans interest free, and therefore, the payment of the premiums using the money loaned by the tribe is believed to qualify as below market split-dollar loans under 26 CFR §1.7872-15 and 26 U.S.C. §7872. Those provisions require that the member pay income tax only on the imputed interest on the loan, using the calculation method set forth in 26 U.S.C. §7872 and 26 CFR §1.7872-15, based on the rates set forth in 26 U.S.C. §1274.

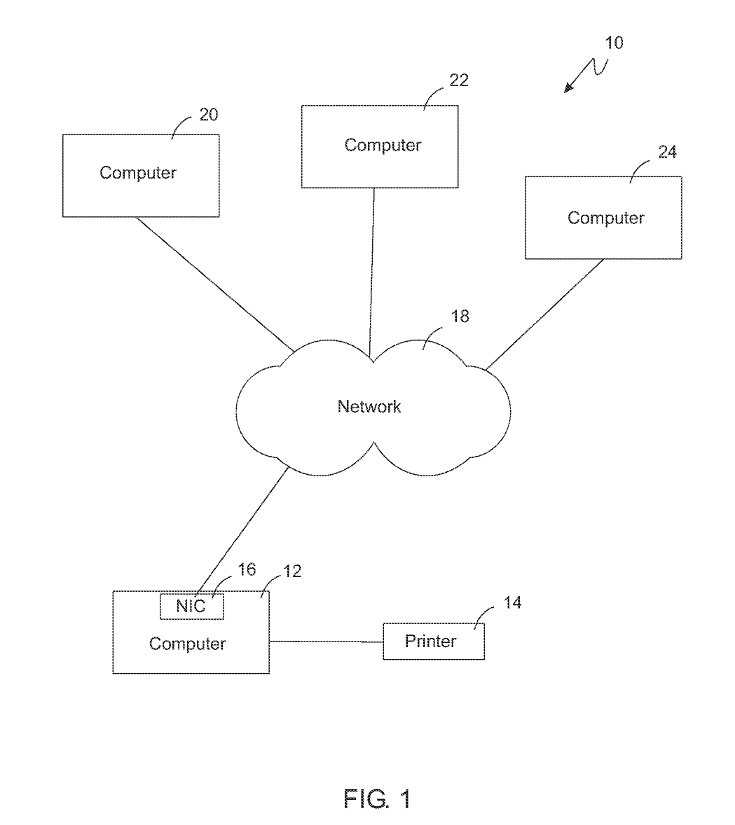

FIG. 1 is a simplified hardware system diagram showing a computer environment in accordance with an embodiment of the present invention. In a computer system 10, a computer 12, which may be a personal computer, is connected to a printer 14. The computer 12 is used for entering actuarial data associated with an applicant to a benefit plan. The computer 12 is also coupled via a computer-to-computer communication device, such as, for example, a network interface card 16, to a network 18, in this case the Internet, for communications with a plurality of computer systems 20, 22, 24 used by one or more insurance carriers, insurance brokers, benefit plan representatives, tribal representatives, tribal members, etc.

The printer 14 is used to print out benefit plan examples and descriptions of insurance policy benefits, as well as the plan agreements. The computer system 10 may be used by a benefit plan representative, a tribal representative or an insurance broker to generate plan presentations and plan agreement contracts, policies, and other plan documents in accordance with the present invention. The computer system 10 may also be used by a tribal member who is looking on the Internet or elsewhere for information about the plan, for investment options, and who is conducting email or other electronic communications with representatives of the other parties to the plan.

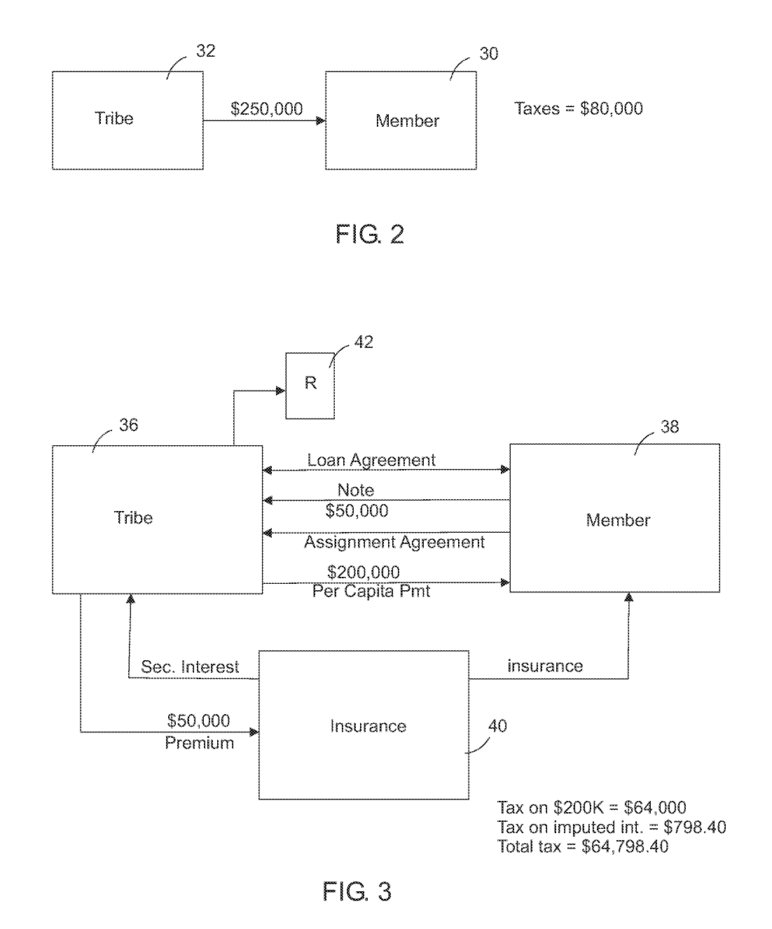

FIG. 2 illustrates an example of a per capita payment and related tax effects when embodiments of the invention are not used. In a given year, a tribal member 30 in this example receives a per capita payment of $250,000 from his/her tribe 32 as a result of gaming activity profits. Assuming this member 30 is in the 32% tax bracket and that this is the only income received for the year, then it is believed that federal taxes in the amount of about $80,000 would be owed to the IRS under current regulations.

FIG. 3 illustrates the contractual arrangements between a tribe 36, a tribal member 38 and an insurance company 40 or other insurance provider along with the tax savings in accordance with an embodiment of the invention. The tribe 36 issues a tribal resolution 42, or any other authorization pursuant to tribal law, agreeing to enter into this transaction and waiving its sovereign immunity from suit for purposes of enforcement of the agreements associated with the arrangement.

The tribe 36 and the member 38 execute benefit plan documents comprising a loan agreement, a note and an assignment agreement. The insurance company 40 issues a life insurance policy to be owned by the member 38. The policy has both a death benefit and a cash surrender value, portions of each of which are allocated to both the member 38 and the tribe 36. Rather than pay a $250,000 per capita payment as shown in FIG. 2, the tribe 36 pays a per capita payment of $200,000 to the member 38 as directed by the member 38 pursuant to these benefit plan documents.

The member 38 signs a promissory note for an interest-free loan and thereby borrows the difference, or $50,000, from the tribe 36. The loan is a term loan, ie., for a predetermined time period, such as for example 20 years, but is payable not later than on or about the date of death of the member 38. To secure repayment to the tribe 36 of the interest-free loan, the member 38 also executes the assignment agreement assigning to the tribe 36 a security interest in the member's 38 right to receive the at least a portion of cash surrender value and death benefit from the insurance policy. The tribe 36 pays the $50,000 loan proceeds directly to the insurance company as an annual policy premium.

Under current IRS regulations and prevailing interest rates, the annual imputed interest on the $50,000 interest-free loan is believed to be about $2,495.00 which would be imputed income to the member 38 for tax purposes. Therefore by using the arrangement of FIG. 3, it is believed that the member 38 would owe current year federal taxes of about $64,000 on the $200,000 per capita distribution plus an additional amount of about $798.40 federal taxes on the imputed interest as calculated pursuant to IRS regulations on the interest-free loan received from the tribe 36. As can be seen, this total of $64,798.40 federal taxes is substantially less than the taxes owed in the example of FIG. 2.

In alternative embodiments, the loan from the tribe 36 could be other than an interest-free loan. For example the loan could require the payment of interest at below-market rates within the meaning of IRS regulations which nevertheless would still result in federal tax liability for an imputed interest amount. In another example, the loan interest could be at rates that are not below-market (within the meaning of IRS regulations) in which event there would be no federal tax liability for an imputed interest amount.

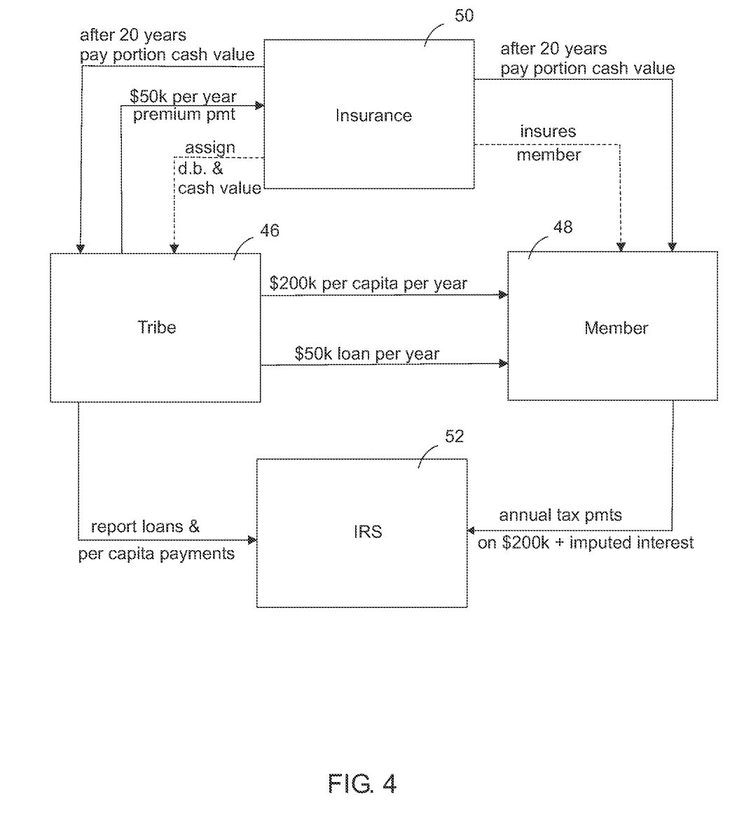

FIG. 4 is a simplified diagram showing the flow of funds between various entities at the beginning and the end of a time period during which an insurance policy is in force according to an embodiment of the invention. There is shown a tribe 46, a tribal member 48, an insurance provider 50, and the IRS 52.

During the first year, the tribe 46 makes a per capita payment in the amount of $200,000 to the member 48. Additionally, the tribe 46 makes an interest-free loan in the amount of $50,000 to the member 48. However, pursuant to a loan agreement, the loan proceeds are paid directly from the tribe 46 to the insurance provider 50 to be used as an annual policy premium on a life insurance policy owned by the member 48, but at least a portion of the cash value and death benefits of which are assigned to the tribe 46 as collateral for the loan. At the end of this first year, the tribe 46 reports the per capita payment of $200,000 and the interest free loan to the IRS 52. Also, the member 48 pays taxes to the IRS 52 based on income corresponding to the per capita payment plus the imputed interest relating to the interest free nature of the loan.

Each year, a new promissory note in the amount of the annual policy premium is executed by the member 48, a new assignment agreement is executed, and the above-described pattern of payments is repeated. Each annual payment is considered a new loan and is accounted for and reported to the IRS 52 by the tribe 46 as a new loan. However the payments do not have to be the same each year. The member 48 elects from year to year how much of an annual policy premium is to be paid, and the tribe 46 extends a loan to the member 48 in the amount of the elected annual policy premium and makes a per capita payment to the member 48 equal to an amount of money that the member 48 otherwise would have received less the loan amount. Also during these years, the member 48 provides instructions to the insurance provider 50 as to how the policy funds are to be invested. Thus variations in the policy premiums paid and the rate of return on the investments selected by the member 48 will affect both the death benefit and cash surrender value of the insurance policy.

Still referring to FIG. 4, at the end of the loan term (or when the member 48 desires to terminate the policy if prior to the loan term), say after 20 years, for example, the cumulative debt associated with the plurality of annual loans becomes due. At this point, the insurance provider 50 pays at least a portion of the cash surrender value of the policy directly to the tribe 46. The amount paid to the tribe 46 is equal to the total of the annual loans that the tribe 46 made to the member 48 for premium payments. Additionally, the insurance provider 50 pays any balance of the cash surrender value of the policy directly to the member 48.

After the loan is repaid, the tribe 46 places this money in the tribe's treasury and may use the funds in any manner that the tribe 46 sees fit. The tribe 46 has the discretion to use the money to provide funding for essential governmental programs and services to its members, including per capita or other payments, and is obligated to meet the requirements of any provisions of the Internal Revenue Code and the regulations promulgated pursuant thereto that apply to such use. Therefore in deciding whether to participate in this benefit plan, the member 48 should weigh the foregoing flow of funds, etc. against the advantages of the plan, including the death benefit features, investment returns and current-year tax deferrals.

In formulating a benefit plan, a plan sponsor selects an insurance company or insurance provider whose products are intended to be used in conjunction with the benefit plan. Software provided by the selected insurance company is used for computations. The insurance company software, after considering the inputted premium data and actuarial data, renders a death benefit amount and cash surrender value for funding the benefit plan contemplated for the tribal member. A policy software illustration and an actual policy based on the inputted data are printed out on the printer 14 (FIG. 1).

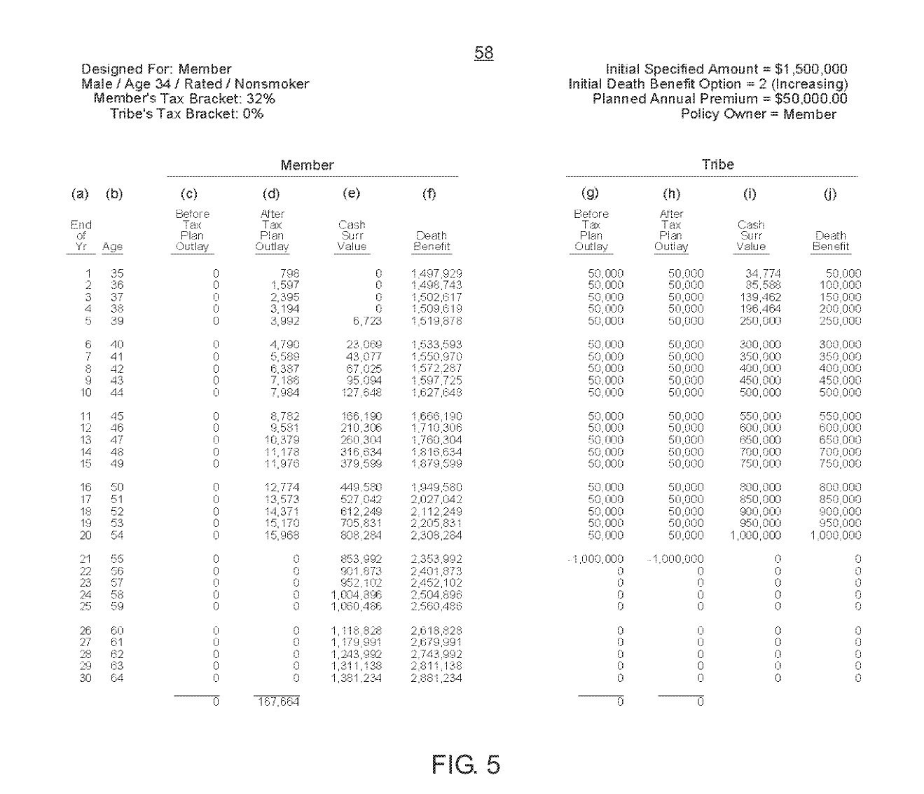

FIG. 5 is an illustration chart 58 of an exemplary build-up of a death benefit and a cash surrender value over time in a variable universal life insurance policy in accordance with an embodiment of the invention. The death benefit and cash surrender value are allocated between a tribal member and a Native American Indian tribe. The dollar amounts in FIG. 5 assume a policy owner who is a 34 year old male tribal member in a 32% tax bracket who does not smoke and who is planning on paying annual premiums of $50,000 for 20 years. This will yield a $1,500,000 life insurance policy with a build up of a death benefit and cash surrender value over time as shown. This illustration further assumes that during the time period shown, the member directed the investments of the policy funds such that an average annual return on the investments was 8%.

Column (d), the after tax plan outlay, represents the income taxes owed each year by the member for the imputed interest on the $50,000 annual interest-free loans extended by the tribe. In other words, column (d) represents the extra taxes owed by the member each year due to his or her participation in the benefit plan. This amount of the after tax plan outlay increases each year as a result of the increase in the interest-free, cumulative debt owed to the tribe as a result of executing a new promissory note each year in the amount of that year's annual policy premium.

Columns (e) and (f) represent the cash surrender value and death benefit value payable directly to the member from the insurance company. Columns (g) and (h) represent the annual policy premiums paid to the insurance company by the tribe as a result of the loan agreement between the tribe and the member. Because Native American Indian tribes are not required to pay federal income taxes, a 0% tax bracket is used for the calculations and figures in columns (g) and (h).

Columns (i) and (j) represent the cash surrender value and the death benefit value payable to the tribe by the insurance company for the policy year in question. Thus columns (i) and (j) represent the capacity for repayment of the premium loans that were extended to the member by the tribe. Note that the policy is structured so that the death benefit payable to the tribe is equal to the total debt owed by the member for the policy premiums. Thus should the member die at any point in time while the debt is outstanding, the tribe will be repaid in full from the policy.

At the end of 20 years the cash surrender value shown in column (i) is $1,000,000 which equals the total of the annual premiums paid for this time period and the total debt owed by the member to the tribe. Because the loans are structured to terminate after 20 years in this example, the insurance company would pay the $1,000,000 cash surrender value directly to the tribe to discharge this debt. The member will receive the amount in column (e), or $808,284, representing the portion of the cash surrender value that the policy pays directly to the member. Alternatively however, the member could elect to not receive the amount in column (e) at that point in time. Rather he or she could elect to allow the cash surrender value and death benefit to continue to grow as a result of the investments within the policy, without the need for further policy premium payments.

As seen in column (j), the split-dollar life policy is structured so that should the member die at any time during the first 20 years of the plan, the death benefit payable to the tribe equals the total amount of the loans extended by the tribe to the member for premium payments. This death benefit was assigned as collateral for the loans, and therefore, should the member die at any point in time during the first 20 years, the death benefit is paid by the insurance company to the tribe and will extinguish the loan obligation of the member's estate.

Note that in this example, any termination of the policy by the member on or after 5 years will result in full repayment to the tribe of the policy premiums (i.e. the debt) paid from the cash surrender value as shown in column (i). However, should the member terminate the policy prior to the end of the 5^{th} year, then its cash surrender value shown in column (i) is less than the total of the policy premiums paid. Accordingly, the member would have an outstanding loan obligation for the difference to the tribe pursuant to the terms of the loan.

For example, if the member desired to terminate the policy at the end of year two, loans from the tribe for the premiums would total $100,000. However, the cash surrender value paid to the tribe would be $85,588. While the insurance company would pay this sum to the tribe to be treated as partial repayment of the member's loan obligation, the difference, or $14,412, still would be owed by the member to the tribe. It therefore usually is not desirable for a member to terminate a policy too early in the plan period.

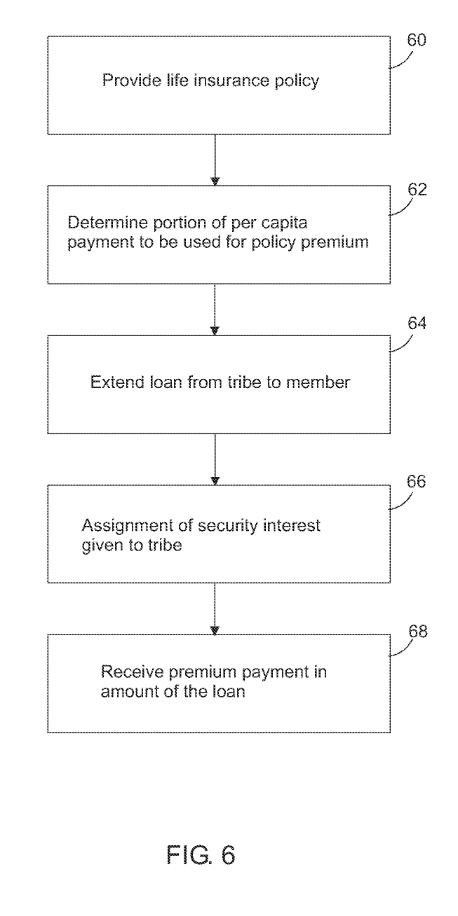

FIG. 6 is a flow chart diagram of an embodiment of the present invention that is performed at least in part within a computer. A life insurance policy to be owned by a member of a Native American Indian tribe and having a policy benefit comprising a death benefit and a cash surrender value is provided. 60 The member determines the portion of what otherwise would be his or her full per capita payment that is to be used for the annual policy premium for that year. 62 A loan is extended from the Native American Indian tribe to the member to generate loan proceeds. 64 The loan is secured by an assignment from the member to the tribe of a security interest in at least a portion of both the death benefit and cash surrender value of the life insurance policy. 66 A premium payment for the life insurance policy is received by the insurance provider wherein at least a portion of the premium payment is obtained from the loan proceeds. 68

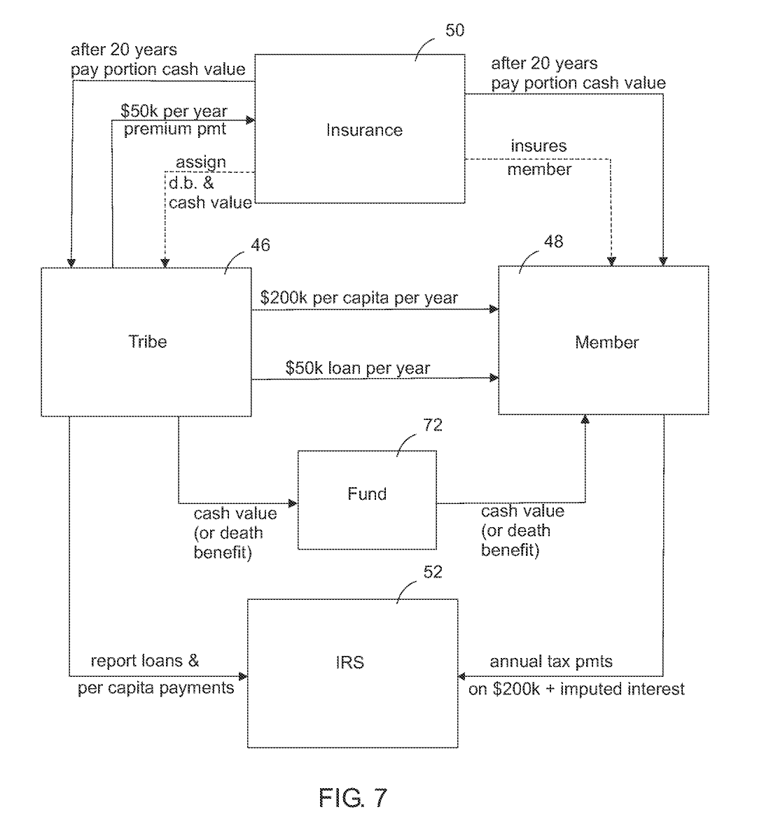

FIG. 7 is a simplified diagram showing the flow of funds between various entities at the beginning and the end of a time period during which an insurance policy is in force according to another embodiment of the invention. The flow of funds as shown in FIG. 7 is essentially the same as previously described in connection with FIG. 4. One exception, however, is the creation by the tribe 46 of a fund 72 for the handling of the cash value or death benefit proceeds received by the tribe 46 from the insurance provider 50.

Pursuant to this embodiment, the tribe 46 enacts an ordinance or other tribal law that establishes the fund 72. The fund 72 is kept separate from other operating funds or other types of funds and accounts that may be maintained by the tribe 46. The ordinance requires the tribe 46 to place insurance cash value or death benefit proceeds into this fund 72 and later transfer this money (adjusted for any investment gains, losses and administration expenses) from the fund 72 to the member 48 under certain conditions. The fund 72 can be used for no other purposes by the tribe 46.

This program therefore may be attractive to many members as it imposes a requirement upon the tribe 46 to pay money to the members in an amount that corresponds to that part of the unearned income that was not initially received in earlier years but instead was used as loan proceeds for payment of insurance policy premiums. Participating members will be entitled to receipt of this money upon fulfillment of conditions set forth by the tribe 46 in establishing or managing the program, including but not limited to:
(a) the attainment of a predetermined age, such as for example age fifty-five years,
(b) the providing by the members of individual elections relating to (i) each member's age for commencement of receiving at least a portion of this money, and (ii) a rate of payment by the Native American Indian tribe of this money to the member, and
(c) the repayment by each of the members of all loans extended to the each member by the tribe in connection with the policy premium payments made in prior years.

When the insurance provider 50 sends a portion of the policy benefits to the tribe 46 pursuant to the terms of an insurance policy, the ordinance requires the tribe 46 to deposit this money into the fund 72. At that time the member 48 (in the case of cash value benefits) provides the tribe 46 with an election to participate in the fund and an election regarding the rate of payment or distribution of this money, i.e., whether to receive a lump sum distribution or period payments, and at what age of the member 48 that the payment or payments are to commence. If all loans and debts owing by the member 48 to the tribe 46 (relating to the annual insurance premium payments of earlier years) have been repaid either by receipt of a portion of the policy benefits or otherwise, the member 48 is eligible to participate in the fund and his/her election will be honored. Once this election is made, it is irrevocable.

When the member's election is received (and assuming that an immediately payable, lump sum distribution election is not made), a separate account is established within the fund for the further monitoring and handling of the money associated with the member 48. Separate accounts are maintained within the fund, so that each tribe member has an account associated with that member. The member 48 can direct the investment of the money in this account until such time that it is paid to the member 48 pursuant to his/her election. Thus the amount of money paid to the member 48 pursuant to his/her election is the balance in the member's account which corresponds to the portion of the policy benefit deposited by the tribe 46 into the fund 72, i.e., the amount received from the insurance provider 50 as the policy benefit plus any gains received as a result of the investments of the funds in this account, less any losses suffered by these investments, and less a portion of the administrative expenses incurred in the administration of the fund 72.

One condition under which there would not be an entitlement to receive the full balance in the account relates to the member's age. Should the member 48 die prior to reaching a predetermined age, such as for example age fifty-five years, then the member's estate or beneficiary would only be paid a predetermined amount of money that is other than the account balance. This amount of money and predetermined age are established by the tribe at the time that the tribal ordinance is enacted or at some other time prior to the death of the member 48. This amount of money is a fixed dollar amount that is the same for all participating members regardless of the balance in their respective accounts.

The balance of the money in this account, less the predetermined amount being paid to the member's estate or beneficiary, would revert to the tribe 46 and be spent as the tribal leaders see fit for use for the general benefit of all of the tribe members. The predetermined amount of money that is to be paid to the member's estate or beneficiary is quite small in relation to the balance in the member's account under most circumstances. According to an embodiment of the invention, this predetermined amount is set at $50,000.00. However, other amounts could be established as well. On the other hand, should the member die on or after the predetermined age, then the full balance in the account would be paid to the member's estate or designated beneficiary.

Some of the steps described above in connection with FIGS. 3-7 may be performed by a plan representative, insurance agent, or plan provider prior to the time in which a specific tribal member who is applying for a plan requests a policy. For example, a table of data (generated, for example, by policy software using the computer system 10 of FIG. 1) may be produced ahead of time showing costs, premiums, etc. for many different potential tribal member plan applicants and policy details and benefits.

Embodiments of the present invention may be implemented, in whole or in part, with any combination of hardware and software. It is to be understood that while various communications taking place between various computers may be conveniently accomplished via electronic mail, other forms of communication may also be employed, such as, for example, postal mail, telephone or other forms of communication. Also, the policy benefit calculations, such as those of the type shown in FIG. 5, may be accomplished by the insurance company computer, the plan representative computer, or by any other computer.

An embodiment of the invention is further explained in Appendix A which is an example of a tribal ordinance for the establishment and operation of a fund, such as the fund 72 of FIG. 7. In this example, the tribe establishes a voluntary program that includes a fund for holding the money received from the insurance provider of a participating tribal member as the repayment of the loans extended to the member in prior years. The amounts appropriated to this fund are required to be transferred from the tribe's general fund within 30 days of receipt by the tribe of the member's election to participate in the program. The program further establishes an office of the program administrator that is responsible for keeping the fund accounts and the individual accounts according to accounting standards, for managing the accounts according to each participating member's elections and investment instructions, for reporting certain transactions to the IRS as required by law, etc.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

### APPENDIX A

ORDINANCE NO. ______

AN ORDINANCE OF THE TRIBAL COUNCIL OF THE ______ INDIANS ENTITLED “TRIBAL SOCIAL SECURITY ORDINANCE.”

The Tribal Council (“Council”) of the ______ Indians (“Tribe”) hereby ordains as follows:

Section 1. Declaration of Intent.

The Tribal Council declares that it is the intention of the Tribe to create a voluntary program to provide financial security to members of the Tribe who have reached retirement age. The program shall be entitled the “Tribal Social Security Program.”

Section 2. Establishment of Tribal Social Security Program.

There is hereby established the Tribal Social Security Program. The Tribal Social Security Program shall be operated in accordance with the provisions of this Ordinance.

Section 3. Definitions.

As used in this Ordinance, the following terms shall have the following meanings:

A. “Administration Fees” means all fees imposed by the Tribe to cover the costs of administering the Tribal Social Security Program, including, but not limited to:

(1) costs incurred by the tribe in employing a Program Administrator, including costs arising from the maintenance of an office of Program Administrator;

(2) fees paid to a third party administrator with whom the Tribe has contracted to act as the Program Administrator; and

(3) transaction fees or other fees charged by an investment fund or brokerage firm on the purchase or sale of securities or other investments.

(4) Under any circumstances, the administration fees imposed under this Ordinance shall not exceed ______ of the total amount of money in the Tribal Social Security Fund as of the last day of any fiscal year.

B. “Tribal Social Security Program Administrator” means an employee of the tribal government assigned to manage the Tribal Social Security Accounts or a licensed third party administrator under contract with the Tribe to provide program administration services on behalf of the Tribe.

C. “Program Participant” means any tribal member who elects to participate in the Tribal Social Security Program.

D. “Third Party Administrator” means a person or entity under contract with the Tribe to administer the Social Security Fund.

Section 4. Establishment of the Tribal Social Security Fund

There is hereby created on the books of the Tribal Treasury a fund to be known as the “Tribal Social Security Fund.” The Tribal Social Security Fund shall consist of the moneys appropriated to the Fund pursuant to this section, and any interest or investment income that accrues on those moneys. Any Tribal Social Security Fund money that has been allocated by the Tribal Council shall be kept in an account or accounts that are separate from other tribal accounts and shall be accounted for separately from other tribal funds. The funds in the Tribal Social Security Fund shall not be commingled with other tribal funds.

Section 5. Appropriation of Tribal Money to Fund.

There is hereby appropriated to the Tribal Social Security Fund for the fiscal year ending ______, 200______, and for each fiscal year thereafter, out of funds in the Tribal Treasury, amounts equivalent to 100 percent of the money deferred from the per capita payments of all Program Participants pursuant to Section ______, below, and 100 percent the money repaid to the Tribe by all Program Participant under the Tribe's Split Dollar Life Insurance Program

The amounts appropriated under this section shall be transferred from the Tribe's general fund to the Tribal Social Security Fund within 30 days of receipt by the Tribe of the eligible tribal member's election to participate in the Tribal Social Security Program.

Section 6. Tribal Social Security Program Administrator.

There is hereby established the office of the Tribal Social Security Program Administrator. The duties of the Program Administrator shall include, but shall not be limited to:

(1) Keeping the accounts of the Tribal Social Security Fund and the individual Program Participant accounts established pursuant to this Ordinance, in accordance with GAAP standards;

(2) Establishment of an individual account for each Program Participant in an amount equal to the amount of money repaid to the Tribe by each Program Participant under the Tribe's Split Dollar Loan Life Insurance Program.

(3) Obtaining each Program Participant's election as to the timing, manner and amount of benefits to be distributed;

(4) Obtaining each Program Participant's election as to how the money in his/her account is to be invested;

(5) Instructing the Tribal Treasurer as to the amount and timing of the distribution of benefits to each Program Participant;

(6) Preparing all necessary documentation to allow the Tribal Treasurer to report to the Internal Revenue Service all distributions made to Program Participants;

(7) Preparing documentation to inform the Tribal Treasurer as to any amounts that need to be withheld from individual distributions, if any withholding is required, in accordance with the provisions of any applicable tribal ordinance or resolution or any applicable provisions of the Internal Revenue Code;

(8) Preparing IRS Form 1099s and any other forms required under the Internal Revenue Code to be issued to Program Participants by the Tribe.

(9) Taking any other action that is required to ensure that the Tribe carries out its obligations under this Ordinance and applicable federal law.

Section 7. Eligibility for Program/Notice of Election to Participate.

Every tribal member who has participated in the Tribe's Split Dollar Life Insurance Program and who has repaid, in full, his or her loans from the Tribe made pursuant to the Tribal Split Dollar Life Insurance Program shall be eligible to participate in the Tribal Social Security Program.

Any eligible tribal member who wishes to participate in the Tribal Social Security Program shall inform the Tribe of his/her election to do so in writing, in a form to be established by the Tribal Treasurer. At the time of his/her election to participate in the program, the eligible tribal member shall inform the Tribe as to his/her election as to the distribution of benefits under the Tribal Social Security Program, pursuant to Section 11.

Section 8. Establishment of Individual Accounts.

Once the funds appropriated under this Ordinance are transferred from the Tribe's general fund to the Tribal Social Security Fund, and the Program Participant had made his/her election as to the distribution of benefits provided for in Section 11, the funds shall be distributed into separate accounts established in the name of each of the Program Participants, in an amount corresponding to the amount of money repaid by each Program Participant to the Tribe under the Split Dollar Life Insurance Program. Once funds are distributed to an individual account, the Tribe shall not authorize the use of those funds for any other purpose or distribute the funds to anyone other than the Program Participant in whose name the account was established, the Program Participant's guardian or conservator pursuant to Section 12, or the Program Participant's estate, pursuant to Section 13, unless the funds revert to the Tribe pursuant to Section 13.

Section 9. Investment of Funds in Individual Accounts.

The funds distributed to the individual accounts shall be invested by the Program Administrator, pursuant to the instructions for investment given by the Program Participant to the Tribal Account Administrator, so long as such investment is made in compliance with all applicable federal and state laws and regulations. Any increase or decrease in the value of the Program Participant's account shall be credited to or debited from the Program Participant's account. The Tribe shall not be responsible for reimbursing Program Participants for any decrease in the value of the account resulting from the Program Participant's investment instructions.

Section 10. Determination of Benefits.

The amount of the benefits to which any Program Participant is entitled shall be equal to:

A. The amount of money paid to the Tribe in repayment for the loans made by the Tribe to the Program Participant under the Tribe's Split Dollar Loan Insurance Program, plus

B. The amount of interest or other investment income that has accrued on Program Participant's investments, minus

C. The amount of any loss in the value of the account resulting from the investment of the funds in the individual account, minus

D. The amount of all applicable administration fees charged to the account.

Section 11. Distribution of Benefits.

Benefits to which any Program Participant is entitled shall be distributed in accordance with the election made by the Program Participant at the time that the Program Participant enlists in the Program, and that decision shall be irrevocable. The Program Participant's election as to distribution of benefits shall be made by informing the Tribal Treasurer, in writing, in a form to be established by the Tribal Treasurer, of his/her preferences relating to the following options:

A. Age: the Program Participant shall inform the Account Administrator as to what age he/she will begin to receive benefits under the program.

B. Lump sum or Periodic Payments: the Program Participant shall decide whether he/she will receive all of his or her benefits in a lump some or in periodic payments made on a monthly, semi-annual, or annual basis. Where the Program Participant chooses to receive periodic payments, the member shall determine the amount of the periodic payments, which shall continue until the Program Participant's account is exhausted.

Section 12. Distribution of Assets Upon Granting of Power of Attorney or a Finding of Incompetence

A. Where a Program Participant executes a power of attorney authorizing another person to make decisions on behalf of the Program Participant relating to the Program Participant's account, the Account Administrator shall honor such instructions. Any power of attorney submitted pursuant to this section must be executed in conformity with applicable tribal law, or, where there exists no applicable tribal law, then in conformity with the applicable law of the State of California.

B. Where a Program Participant is declared by a court of competent jurisdiction to be legally incompetent, and the court appoints a guardian or conservator, the Tribe, acting through the Program Administrator shall honor the instructions of the guardian with regard to the distribution of money in the Program Participant's account.

Section 13. Distribution of Individual Account Assets Upon the Death of the Program Participant.

In the event that a Program Participant dies before reaching the age of fifty-five (55), the Program Participant's heirs shall receive a death benefit of $50,000, and the remainder of the funds in the deceased Program Participant's account shall revert to the Tribe

In the event that a Program Participant dies after reaching the age of fifty-five (55), any funds remaining in the Program Participant's account shall be distributed to the Program Participant's estate.

Section 14. Reporting and Withholding Pursuant to the Internal Revenue Code.

All distributions of benefits made pursuant to this program shall be reported to the United States Internal Revenue Service pursuant to the applicable provisions of the Internal Revenue Code. The Tribe shall also withhold any amounts required under the provisions of the Internal Revenue Code. The Tribe shall issue IRS Code Form 1099s to each Program Participant receiving benefits in any calendar year.

Section 15. Authorization to Contract with Third Party Administrator.

The Tribal Council is hereby authorized to enter into a professional services contract with a person or entity with the qualifications set forth in this Ordinance, to carry out the duties of the Tribal Social Security Account Manager on behalf of the Tribe. Any third party administrator who contracts with the Tribe pursuant to this Ordinance shall be considered a tribal official and shall be protected by the Tribe's sovereign immunity. Any claims brought against the third party administrator in his/her official capacity to enforce the provisions of this Ordinance shall be subject to the limitations set forth in the limited waiver of sovereign immunity granted in Section 17, below.

Section 16. Qualifications of Third Party Administrator.

A third party administrator with whom the Tribe contracts shall have the following minimum qualifications:

(1) ______.

(2) ______.

Section 17. Limited Waiver of Tribal Sovereign Immunity.

The Tribe waives its sovereign immunity as to any claims brought by a Program Participant for the purpose of enforcing the Program Participant's rights under this Ordinance. This waiver applies only to claims for money damages based on the Program Participant's entitlement to benefits under the Program and/or claims for injunctive relief seeking an order for the payment of money to which the Court determines the Program Participant is entitled. Any such award of damages or court order requiring payment shall only apply to the money in the Social Security Fund. This limited waiver of sovereign immunity does not extend to claims or orders relating to any other assets of the Tribe. This waiver does not extend to any award of damages beyond the Program Participant's entitlement under the Program, and does not apply to punitive damages, damages based on reliance, pain and suffering, emotional distress, or lost opportunity, and the Tribe reserves the right to assert sovereign immunity as a defense against any such claims. Any claim brought pursuant to this waiver of sovereign immunity shall be brought in the ______ court.

This limited waiver of sovereign immunity shall be incorporated into any contract entered into with any Third Party Administrator under Section 15, above.

Section 18: Severability.

If any part of this Ordinance is held invalid, the remainder of the Ordinance shall not be affected thereby and shall continue in full force and effect. To this end, the provisions of this Ordinance are severable.

Section 19. Effective Date.

This Ordinance shall take effect immediately upon its enactment by the Tribal Council.

### Certification

The foregoing Ordinance was adopted at a duly convened meeting of the ______ Tribal Council, with a quorum present, held on the ______th day of ______, 200______, by the following vote:

AYES:

NOES:

ABSENT:

ABSTAIN:

______, Chairman
   ATTEST:
   ______, Secretary

What is claimed is:

1. A method for creating a benefit plan for a member of a Native American Indian tribe, comprising:
providing a life insurance policy to be owned by the member and having a policy benefit comprising a death benefit and a cash surrender value; and
receiving a premium payment for the life insurance policy,
wherein at least a portion of the premium payment is obtained from loan proceeds generated by a first loan from the Native American Indian tribe to the member,
wherein at least a portion of the loan proceeds is money that otherwise would be paid by the Native American Indian tribe to the member as unearned income,
wherein at least a portion of the policy benefit is to be paid to the Native American Indian tribe for placement by the Native American Indian tribe into a fund established pursuant to tribal law; and
wherein a first sum of money corresponding to the at least a portion of the policy benefit is to be paid by the Native American Indian tribe from the fund to the member upon fulfillment by the member of a plurality of conditions.

2. The method of claim 1 wherein use of the fund is limited to handling money corresponding to the at least the portion of the policy benefit and the first sum of money.

3. The method of claim 1 wherein the method is for creating a plurality of additional benefit plans for a plurality of additional members of the Native American Indian tribe,
wherein providing the life insurance policy includes providing a plurality of additional life insurance policies to be owned by the plurality of additional members and having a plurality of additional policy benefits,
wherein receiving the premium payment for the life insurance policy includes receiving a plurality of additional premium payments for the plurality of additional life insurance policies,
wherein at least a portion of the plurality of additional premium payments is obtained from a plurality of additional loan proceeds generated by a plurality of additional loans from the Native American Indian tribe to the plurality of additional members,
wherein at least a portion of the plurality of additional loan proceeds is money that otherwise would be paid by the Native American Indian tribe to the plurality of additional members as unearned income,
wherein at least a portion of the plurality of additional policy benefits is to be paid to the Native American Indian tribe for placement by the Native American Indian tribe into the fund,
wherein a plurality of additional sums of money corresponding to the at least the portion of the plurality of additional policy benefits is to be paid by the Native American Indian tribe from the fund to the plurality of additional members upon fulfillment by the plurality of additional members of the plurality of conditions, and
wherein use of the fund is limited to handling money corresponding to the at least the portion of the policy benefit, the at least the portion of the plurality of additional policy benefits, the first sum of money and the plurality of additional sums of money.

4. The method of claim 1 wherein the at least a portion of the policy benefit is a second sum of money, wherein the first sum of money is approximately equal to the second sum of money plus gains associated with investment of the second sum of money, minus losses associated with the investment of the second sum of money, minus at least a portion of administration costs relating to administration of the fund.

5. The method of claim 1 wherein one of the plurality of conditions includes one of the attainment by the member of a predetermined age, the providing by the member of an election relating to an age of the member for commencement of receiving at least a portion of the first sum of money, the providing by the member of an election relating to a rate of payment by the Native American Indian tribe of the first sum of money to the member, and the repayment by the member of the first loan.

6. The method of claim 5 wherein another one of the plurality of conditions includes another one of the attainment by the member of the predetermined age, the providing by the member of the election relating to the age of the member for commencement of receiving the at least a portion of the first sum of money, the providing by the member of the election relating to the rate of payment by the Native American Indian tribe of the first sum of money to the member, and the repayment by the member of the first loan.

7. The method of claim 1 wherein a predetermined sum of money is to be paid by the Native American Indian tribe to a recipient if the member dies prior to a predetermined age, wherein the first sum of money is not paid to the recipient if the member dies prior to the predetermined age, wherein the recipient is one of an estate of the member and a beneficiary of the member, and wherein the amount of the predetermined sum of money is established by the North American Indian tribe prior to the death of the member.

8. The method of claim 7 wherein the predetermined sum of money is less than the first sum of money.

9. The method of claim 1 wherein the first loan is secured by a security interest provided by the member to the Native American Indian tribe.

10. The method of claim 9 wherein the security interest is for the at least a portion of the policy benefit.

11. The method of claim 1 wherein the life insurance policy is issued by an insurance provider and wherein the premium payment is sent to the insurance provider by the Native American Indian tribe.

12. The method of claim 1 wherein at least a portion of the death benefit is about equal to the amount of the first loan.

13. The method of claim 1 wherein the life insurance policy is a variable universal life policy.

14. The method of claim 1 wherein the first loan is due for repayment on the earlier of one of a predetermined time period and the death of the member.

15. The method of claim 1 wherein the first loan is repayable with interest at a below-market interest rate.

16. The method of claim 1 wherein the first loan is an interest-free loan.

17. The method of claim 1 wherein the unearned income is at least a portion of a payment generated from business operations of the Native American Indian tribe.

18. The method of claim 17 wherein the payment is a per capita payment.

19. The method of claim 18 wherein the business operations are gaming operations.

20. The method of claim 1 further comprising issuing an authorization pursuant to tribal law wherein the Native American Indian tribe agrees to undertake obligations and to waive a sovereign immunity from suit to allow for enforcement of the obligations, wherein the obligations include providing the first loan to the member and reporting the first loan to the Internal Revenue Service.

21. The method of claim 1 wherein at least one of the foregoing steps is performed at least in part within a computer device.

22. The method of claim 21 wherein use of the fund is limited to handling money corresponding to the at least the portion of the policy benefit and the first sum of money.

23. The method of claim 21 wherein the method is for creating a plurality of additional benefit plans for a plurality of additional members of the Native American Indian tribe,
wherein providing the life insurance policy includes providing a plurality of additional life insurance policies to be owned by the plurality of additional members and having a plurality of additional policy benefits,
wherein receiving the premium payment for the life insurance policy includes receiving a plurality of additional premium payments for the plurality of additional life insurance policies,
wherein at least a portion of the plurality of additional premium payments is obtained from a plurality of additional loan proceeds generated by a plurality of additional loans from the Native American Indian tribe to the plurality of additional members,
wherein at least a portion of the plurality of additional loan proceeds is money that otherwise would be paid by the Native American Indian tribe to the plurality of additional members as unearned income,
wherein at least a portion of the plurality of additional policy benefits is to be paid to the Native American Indian tribe for placement by the Native American Indian tribe into the fund,
wherein a plurality of additional sums of money corresponding to the at least the portion of the plurality of additional policy benefits is to be paid by the Native American Indian tribe from the fund to the plurality of additional members upon fulfillment by the plurality of additional members of the plurality of conditions, and
wherein use of the fund is limited to handling money corresponding to the at least the portion of the policy benefit, the at least the portion of the plurality of additional policy benefits, the first sum of money and the plurality of additional sums of money.

24. The method of claim 21 wherein the at least a portion of the policy benefit is a second sum of money, wherein the first sum of money is approximately equal to the second sum of money plus gains associated with investment of the second sum of money, minus losses associated with the investment of the second sum of money, minus at least a portion of administration costs relating to administration of the fund.

25. The method of claim 21 wherein one of the plurality of conditions includes one of the attainment by the member of a predetermined age, the providing by the member of an election relating to an age of the member for commencement of receiving at least a portion of the first sum of money, the providing by the member of an election relating to a rate of payment by the Native American Indian tribe of the first sum of money to the member, and the repayment by the member of the first loan.

26. The method of claim 25 wherein another one of the plurality of conditions includes another one of the attainment by the member of the predetermined age, the providing by the member of the election relating to the age of the member for commencement of receiving the at least a portion of the first sum of money, the providing by the member of the election relating to the rate of payment by the Native American Indian tribe of the first sum of money to the member, and the repayment by the member of the first loan.

27. The method of claim 21 wherein a predetermined sum of money is to be paid by the Native American Indian tribe to a recipient if the member dies prior to a predetermined age, wherein the first sum of money is not paid to the recipient if the member dies prior to the predetermined age, wherein the recipient is one of an estate of the member and a beneficiary of the member, and wherein the amount of the predetermined sum of money is established by the North American Indian tribe prior to the death of the member.

28. The method of claim 27 wherein the predetermined sum of money is less than the first sum of money.

29. The method of claim 21 wherein the first loan is secured by a security interest provided by the member to the Native American Indian tribe.

30. The method of claim 29 wherein the security interest is for at least a portion of the policy benefit.

31. The method of claim 21 wherein the life insurance policy is issued by an insurance provider and wherein the premium payment is sent to the insurance provider by the Native American Indian tribe.

32. The method of claim 21 wherein the at least a portion of the death benefit is about equal to the amount of the first loan.

33. The method of claim 21 wherein the life insurance policy is a variable universal life policy.

34. The method of claim 21 wherein the first loan is due for repayment on the earlier of one of a predetermined time period and the death of the member.

35. The method of claim 21 wherein the first loan is repayable with interest at a below-market interest rate.

36. The method of claim 21 wherein the first loan is an interest-free loan.

37. The method of claim 21 wherein the unearned income is at least a portion of a payment generated from business operations of the Native American Indian tribe.

38. The method of claim 21 further comprising issuing an authorization pursuant to tribal law wherein the Native American Indian tribe agrees to undertake obligations and to waive a sovereign immunity from suit to allow for enforcement of the obligations, wherein the obligations include providing the first loan to the member and reporting the first loan to the Internal Revenue Service.

39. The method of claim 21 further comprising receiving a plurality of additional premium payments for the life insurance policy,
wherein at least a portion of each of the plurality of additional premium payments is obtained from additional loan proceeds generated by a plurality of additional loans from the Native American Indian tribe to the member, and
wherein at least a portion of the additional loan proceeds is money that otherwise would be paid by the Native American Indian tribe to the member as unearned income.

40. A method for creating a benefit plan for a member of a Native American Indian tribe, comprising:
providing a life insurance policy to be owned by the member and having a policy benefit comprising a death benefit and a cash surrender value; and
receiving a premium payment for the life insurance policy,
wherein at least a portion of the premium payment is obtained from loan proceeds generated by a loan from the Native American Indian tribe to the member,
wherein at least a portion of the loan proceeds is money that otherwise would be paid by the Native American Indian tribe to the member as unearned income,
wherein the loan is secured by a security interest provided by the member to the Native American Indian tribe in at least a portion of the policy benefit,
wherein the life insurance policy is issued by an insurance provider and wherein the premium payment is sent to the insurance provider by the Native American Indian tribe,
wherein the loan is due for repayment on the earlier of one of a predetermined time period and the death of the member,
wherein at least a portion of the policy benefit is to be paid to the Native American Indian tribe for placement by the Native American Indian tribe into a fund established pursuant to tribal law;
wherein a first sum of money corresponding to the at least a portion of the policy benefit is to be paid by the Native American Indian tribe from the fund to the member upon fulfillment by the member of a plurality of conditions, and
wherein at least one of the foregoing steps is performed at least in part within a computer device.

41. The method of claim 40 wherein use of the fund is limited to handling money corresponding to the at least the portion of the policy benefit and the first sum of money.

42. The method of claim 40 wherein the method is for creating a plurality of additional benefit plans for a plurality of additional members of the Native American Indian tribe,
wherein providing the life insurance policy includes providing a plurality of additional life insurance policies to be owned by the plurality of additional members and having a plurality of additional policy benefits,
wherein receiving the premium payment for the life insurance policy includes receiving a plurality of additional premium payments for the plurality of additional life insurance policies,
wherein at least a portion of the plurality of additional premium payments is obtained from a plurality of additional loan proceeds generated by a plurality of additional loans from the Native American Indian tribe to the plurality of additional members,
wherein at least a portion of the plurality of additional loan proceeds is money that otherwise would be paid by the Native American Indian tribe to the plurality of additional members as unearned income,
wherein the plurality of additional loans is secured by a plurality of additional security interests provided by the plurality of additional members to the Native American Indian tribe in at least a portion of the plurality of additional policy benefits,
wherein the plurality of additional life insurance policies is issued by an insurance provider and wherein the plurality of additional premium payments is sent to the insurance provider by the Native American Indian tribe,
wherein at least a portion of the plurality of additional policy benefits is to be paid to the Native American Indian tribe for placement by the Native American Indian tribe into the fund,
wherein a plurality of additional sums of money corresponding to the at least the portion of the plurality of additional policy benefits is to be paid by the Native American Indian tribe from the fund to the plurality of additional members upon fulfillment by the plurality of additional members of the plurality of conditions, and
wherein use of the fund is limited to handling money corresponding to the at least the portion of the policy benefit, the at least the portion of the plurality of additional policy benefits, the first sum of money and the plurality of additional sums of money.

43. The method of claim 40 wherein the at least a portion of the policy benefit is a second sum of money, wherein the first sum of money is approximately equal to the second sum of money plus gains associated with investment of the second sum of money, minus losses associated with the investment of the second sum of money, minus at least a portion of administration costs relating to administration of the fund.

44. The method of claim 40 wherein one of the plurality of conditions includes one of the attainment by the member of a predetermined age, the providing by the member of an election relating to an age of the member for commencement of receiving at least a portion of the first sum of money, the providing by the member of an election relating to a rate of payment by the Native American Indian tribe of the first sum of money to the member, and the repayment by the member of the first loan.

45. The method of claim 44 wherein another one of the plurality of conditions includes another one of the attainment by the member of the predetermined age, the providing by the member of the election relating to the age of the member for commencement of receiving the at least a portion of the first sum of money, the providing by the member of the election relating to the rate of payment by the Native American Indian tribe of the first sum of money to the member, and the repayment by the member of the first loan.

46. The method of claim 40 wherein a predetermined sum of money is to be paid by the Native American Indian tribe to a recipient if the member dies prior to a predetermined age, wherein the first sum of money is not paid to the recipient if the member dies prior to the predetermined age, wherein the recipient is one of an estate of the member and a beneficiary of the member, and wherein the amount of the predetermined sum of money is established by the North American Indian tribe prior to the death of the member.

47. The method of claim 46 wherein the predetermined sum of money is less than the first sum of money.

48. The method of claim 40 wherein the at least a portion of the death benefit is about equal to the amount of the loan.

49. The method of claim 40 wherein the life insurance policy is a variable universal life policy.

50. The method of claim 40 wherein the loan is repayable with interest at a below-market interest rate.

51. The method of claim 40 wherein the unearned income is at least a portion of a per capita payment generated from gaming business operations of the Native American Indian tribe.

52. A method for creating a benefit plan for a member of a Native American Indian tribe, wherein the member owns a life insurance policy issued by an insurance provider and having a policy benefit comprising a death benefit and a cash surrender value, the method comprising:
providing a loan from the Native American Indian tribe to the member thereby generating loan proceeds, wherein the loan is due for repayment on the earlier of one of a predetermined time period and the death of the member;
sending a premium payment for the life insurance policy to the insurance provider, wherein the premium payment is sent to the insurance provider by the Native American Indian tribe, wherein at least a portion of the premium payment is obtained from the loan proceeds, and wherein at least a portion of the loan proceeds is money that otherwise would be paid by the Native American Indian tribe to the member as unearned income;
receiving a security interest from the member in at least a portion of the policy benefit; and
establishing a fund pursuant to tribal law for holding a first sum of money about equal to the at least a portion of the policy benefit, wherein the first sum of money is to be paid to the Native American Indian tribe for placement by the Native American Indian tribe into the fund,
wherein a second sum of money in an amount corresponding to the first sum of money is to be paid by the Native American Indian tribe from the fund to the member upon the fulfillment by the member of a plurality of conditions, and
wherein at least one of the foregoing steps is performed at least in part within a computer device.

53. The method of claim 52 wherein use of the fund is limited to handling money corresponding to the first sum of money and the second sum of money.

54. The method of claim 52 wherein the method is for creating a plurality of additional benefit plans for a plurality of additional members of the Native American Indian tribe,
wherein the plurality of additional member owns a plurality of additional life insurance policies having a plurality of additional policy benefits comprising a plurality of additional death benefits and a plurality of additional cash surrender values,
wherein providing the loan includes providing a plurality of additional loans from the Native American Indian tribe to the plurality of additional members thereby generating a plurality of additional loan proceeds,
wherein sending the premium payment includes sending a plurality of additional premium payments for the plurality of additional life insurance policies to the insurance provider, wherein the plurality of additional premium payments is sent to the insurance provider by the Native American Indian tribe, wherein at least a portion of the plurality of additional premium payments is obtained from the plurality of additional loan proceeds, and wherein at least a portion of the plurality of additional loan proceeds is money that otherwise would be paid by the Native American Indian tribe to the plurality of additional members as unearned income,
wherein receiving the security interest includes receiving a plurality of additional security interests from the plurality of additional members in at least a portion of the plurality of additional policy benefits,
wherein the fund is further for holding a third sum of money about equal to the at least the portion of the plurality of additional policy benefits, wherein the third sum of money is to be paid to the Native American Indian tribe for placement by the Native American Indian tribe into the fund,
wherein a fourth sum of money in an amount corresponding to the third sum of money is to be paid by the Native American Indian tribe from the fund to the plurality of additional member upon the fulfillment by the plurality of additional members of the plurality of conditions, and
wherein use of the fund is limited to handling money corresponding to the first, second, third and fourth sums of money.

55. The method of claim 52 wherein the second sum of money is approximately equal to the first sum of money plus gains associated with investment of the first sum of money, minus losses associated with the investment of the first sum of money, minus at least a portion of administration costs relating to administration of the fund.

56. The method of claim 52 wherein one of the plurality of conditions includes one of the attainment by the member of a predetermined age, the providing by the member of an election relating to an age of the member for commencement of receiving at least a portion of the first sum of money, the providing by the member of an election relating to a rate of payment by the Native American Indian tribe of the first sum of money to the member, and the repayment by the member of the first loan.

57. The method of claim 56 wherein another one of the plurality of conditions includes another one of the attainment by the member of the predetermined age, the providing by the member of the election relating to the age of the member for commencement of receiving the at least a portion of the first sum of money, the providing by the member of the election relating to the rate of payment by the Native American Indian tribe of the first sum of money to the member, and the repayment by the member of the first loan.

58. The method of claim 52 wherein a predetermined sum of money is to be paid by the Native American Indian tribe to a recipient if the member dies prior to a predetermined age, wherein the second sum of money is not paid to the recipient if the member dies prior to the predetermined age, wherein the recipient is one of an estate of the member and a beneficiary of the member, and wherein the amount of the predetermined sum of money is established by the North American Indian tribe prior to the death of the member.

59. The method of claim 58 wherein the predetermined sum of money is less than the first sum of money.

60. The method of claim 52 wherein at least a portion of the death benefit is about equal to the amount of the loan.

61. The method of claim 52 wherein the life insurance policy is a variable universal life policy.

62. The method of claim 52 wherein the loan is repayable with interest at a below-market interest rate.

63. The method of claim 52 wherein the unearned income is at least a portion of a per capita payment generated from gaming business operations of the Native American Indian tribe.

64. An apparatus for creating a benefit plan for a member of a Native American Indian tribe, comprising:
means for providing a life insurance policy to be owned by the member and having a policy benefit comprising a death benefit and a cash surrender value; and
means for receiving a premium payment for the life insurance policy,
wherein at least a portion of the premium payment is obtained from loan proceeds generated by a loan from the Native American Indian tribe to the member,
wherein at least a portion of the loan proceeds is money that otherwise would be paid by the Native American Indian tribe to the member as unearned income,
wherein the loan is secured by a security interest provided by the member to the Native American Indian tribe in at least a portion of the policy benefit,
wherein the life insurance policy is issued by an insurance provider and wherein the premium payment is sent to the insurance provider by the Native American Indian tribe,
wherein the loan is due for repayment on the earlier of one of a predetermined time period and the death of the member,
wherein at least a portion of the policy benefit is to be paid to the Native American Indian tribe for placement by the Native American Indian tribe into a fund established pursuant to tribal law,
wherein a first sum of money corresponding to the at least a portion of the policy benefit is to be paid by the Native American Indian tribe from the fund to the member upon the fulfillment by the member of a plurality of conditions, and
wherein at least one of the means for providing the life insurance policy and the means for receiving the premium payment comprises a computer device.
